(19) United States
(12) Patent Application Publication
(10) Pub. No.: US 2016/0069449 A1
(43) Pub. Date: Mar. 10, 2016

(54) THIN-TYPE GEAR MOTOR AND MUSCLE FORCE ASSISTING DEVICE USING THIN-TYPE GEAR MOTOR

(71) Applicant: Nidec Copal Electronics Corporation, Tokyo (JP)

(72) Inventors: Takashi KANAI, Iruma-shi (JP); Yusuke TANAKA, Iruma-shi (JP)

(73) Assignee: NIDEC COPAL ELECTRONICS CORPORATION

(21) Appl. No.: 14/479,967

(22) Filed: Sep. 8, 2014

(51) Int. Cl. F16H 57/08; G01D 5/249; F16H 1/28

(52) U.S. Cl. CPC F16H 57/08; F16H 1/28; G01D 5/2497

(57) ABSTRACT

In a thin-type gear motor and a muscle force assisting device that uses the thin-type gear motor in which high torque output is achieved, thinness and size and weight reduction are achieved, and further size reduction is achieved by an absolute sensor that is capable of detecting a rotation angle of an output shaft after speed reduction and is situated in a space that is conventionally not used.

### BACKGROUND OF THE INVENTION

1. Field of the Invention

The present invention relates to a thin-type gear motor having high torque output and a muscle force assisting device that uses the thin-type gear motor.

2. Description of the Related Art

Conventionally, a gear motor that has high torque output uses a multistage planetary gear system in which planetary gear mechanisms are stacked together in two stages and a reduction ratio is obtained.

However, in a system such as this, although high torque output can be achieved, there is a disadvantage in that size and weight reduction cannot be achieved.

Utility Model Publication No. S64-35237 is related art.

### SUMMARY OF THE INVENTION

The present invention has been achieved in light of such disadvantages of the past. An object of the present invention is to provide a thin-type gear motor that not only achieves high torque output, is thin, and is capable of being reduced in size and weight, but is also capable of being further reduced in size by an absolute sensor being provided in a conventionally unused space, the absolute sensor being capable of detecting a rotation angle of an output shaft after speed reduction.

In addition, another object of the present invention is to provide a muscle force assisting device that uses a thin-type gear motor, the muscle force assisting device being thin and capable of being reduced in size and weight as a whole, and capable of smoothly assisting movement in a joint area through use of a thin-type gear motor such as that described above.

The description above, other objects, and novel features of the present invention will become more completely clear when the following description is read with reference to the accompanying drawings.

However, the drawings are mainly for description and do not limit the technical scope of the present invention.

To achieve the above-described object, in the present invention, a thin-type gear motor is configured by: an outer-rotor motor; a planetary gear housing case in which an encoder housing chamber is formed that enters a free space present in a center portion of a rotor of the outer-rotor motor; a reduction mechanism that is rotatably provided within the planetary gear housing case, and that reduces the speed of rotation of a shaft of the motor positioned within the planetary gear housing case using planetary gears and transmits the speed-reduced rotation to an output shaft; a rotation position information recording member that is provided in a section of the reduction mechanism corresponding to the encoder housing chamber of the planetary gear housing case and provides an absolute sensor with position information; and the absolute sensor that is provided within the encoder housing chamber of the planetary gear housing case and detects a rotation angle of an output shaft of the reduction mechanism after speed reduction based on the information from the rotation position information recording member.

In addition, in the present invention, a muscle force assisting device is configured by: a thin-type gear motor that is composed of an outer-rotor motor, a planetary gear housing case in which an encoder housing chamber is formed that enters a free space present in a center portion of a rotor of the outer-rotor motor, a reduction mechanism that is rotatably provided within the planetary gear housing case and that reduces the speed of rotation of a shaft of the motor positioned within the planetary gear housing case using planetary gears and transmits the speed-reduced rotation to an output shaft, a rotation position information recording member that is provided in a section of the reduction mechanism corresponding to the encoder housing chamber of the planetary gear housing case and provides an absolute sensor with position information, and the absolute sensor that is provided within the encoder housing chamber of the planetary gear housing case and detects a rotation angle of an output shaft of the reduction mechanism after speed reduction based on the information from the rotation position information recording member; a second arm of which one end portion is attached to the planetary gear housing case of the thin-type gear motor; a first arm of which one end portion is attached to an output shaft of the thin-type gear motor; a first mounting member that is attached to a section near the tip end portion of the first arm and attached to a section projecting further than a joint section so that the thin-type gear motor section is the joint section; and a second mounting member that is attached to a section near the tip end portion of the second arm and attached to a section projecting further than a joint section so that the thin-type gear motor section is the joint section.

As is clear from the description above, the present invention achieves the following effects:

(1) According to a first aspect, the planetary gear housing case is used in which the encoder chamber is formed that enters a free space present in the center portion of the rotor of the outer-rotor motor. In addition, the rotation position information recording member that provides the absolute sensor with position information is provided in the section corresponding to the encoder housing chamber. Furthermore, the absolute sensor that is capable of detecting the rotation angle of the output shaft after speed reduction is provided in the encoder housing chamber. Therefore, size and weight can be reduced compared to when the setting location of the absolute sensor is on the conventional final output side.

(2) According to a second aspect, in addition to effects similar to above-described (1) being achieved, shaft instability when unbalanced load occurs can be prevented with certainty as a result of the sensor base and the carrier mount that serve as a planetary carrier of the reduction mechanism supporting the plurality of planetary two-stage gears and the plurality of planetary gears. In addition, significant speed reduction and high torque output can be achieved. Thinness and size and weight reduction of the speed reduction section can be achieved.

(3) According to a third aspect, in addition to effects similar to above-described (1) being achieved, because the gear ratio of the large gear and the small gear of the planetary two-stage gear is not an integral multiple, reduction ratio (gear ratio) of the overall reduction mechanism can be specifically set. Therefore, freedom in design can be significantly improved.

(4) According to fourth and fifth aspects, in addition to effects similar to above-described (1) being achieved, movement in a joint area can be smoothly assisted.

### BRIEF DESCRIPTION OF THE DRAWINGS

FIG. 1 is a cross-sectional view taken along line 1-1 in FIG. 2;

FIG. 2 is a planar view according to the first embodiment for carrying out the present invention;

FIG. 3 is a bottom view according to the first embodiment for carrying out the present invention;

FIG. 4 is an explanatory diagram of a meshing state of planetary gears according to the first embodiment for carrying out the present invention;

FIG. 5 is an explanatory diagram of a planetary two-stage gear according to the first embodiment for carrying out the present invention;

FIG. 6 is a planar view of an attachment state of the planetary gears according to the first embodiment for carrying out the present invention;

FIG. 7 is a cross-sectional view taken along line 7-7 in FIG. 6;

FIG. 8 is a cross-sectional view taken along line 8-8 in FIG. 7;

FIG. 9 is an explanatory cross-sectional view according to a second embodiment for carrying out the present invention;

FIG. 10 is a planar view (1) according to the second embodiment for carrying out the present invention;

FIG. 11 is a planar view (2) according to the second embodiment for carrying out the present invention;

FIG. 12 is a side view of a usage state according to the second embodiment for carrying out the present invention;

FIG. 13 is a front view of a usage state according to the second embodiment for carrying out the present invention;

FIG. 14 is an enlarged view of section A in FIG. 12;

FIG. 15 is a cross-sectional view taken along line 15-15 in FIG. 16;

FIG. 16 is a planar view according to the third embodiment for carrying out the present invention;

FIG. 17 is a planar view of an attachment state of planetary gears according to the third embodiment for carrying out the present invention;

FIG. 18 is an explanatory cross-sectional view according to a fourth embodiment for carrying out the present invention;

FIG. 19 is a planar view according to the fourth embodiment for carrying out the present invention; and

FIG. 20 is an explanatory diagram of a reduction mechanism according to the fourth embodiment for carrying out the present invention.

### DETAILED DESCRIPTION OF THE INVENTION

The present invention will be described in detail based on embodiments for carrying out the present invention shown in the drawings.

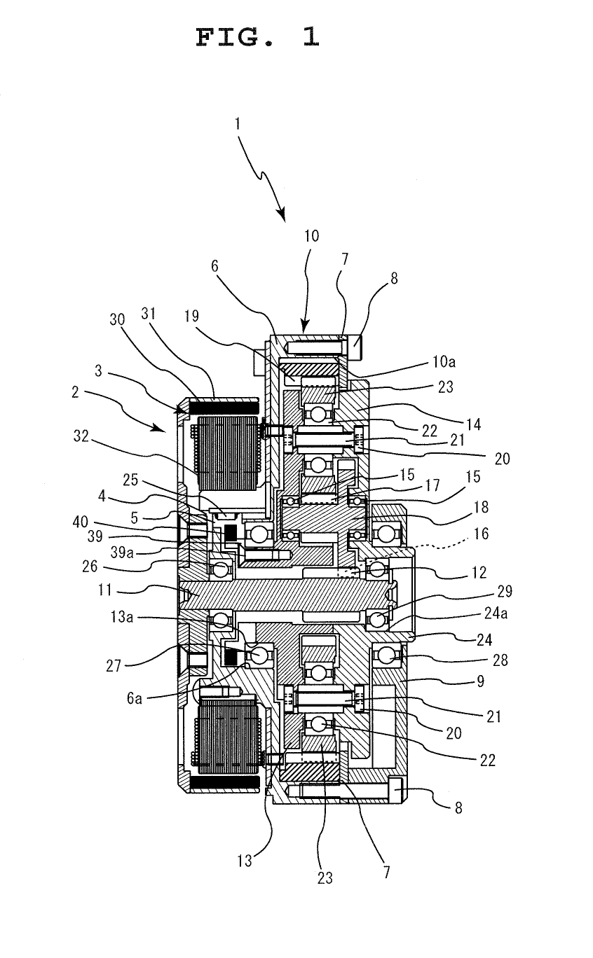

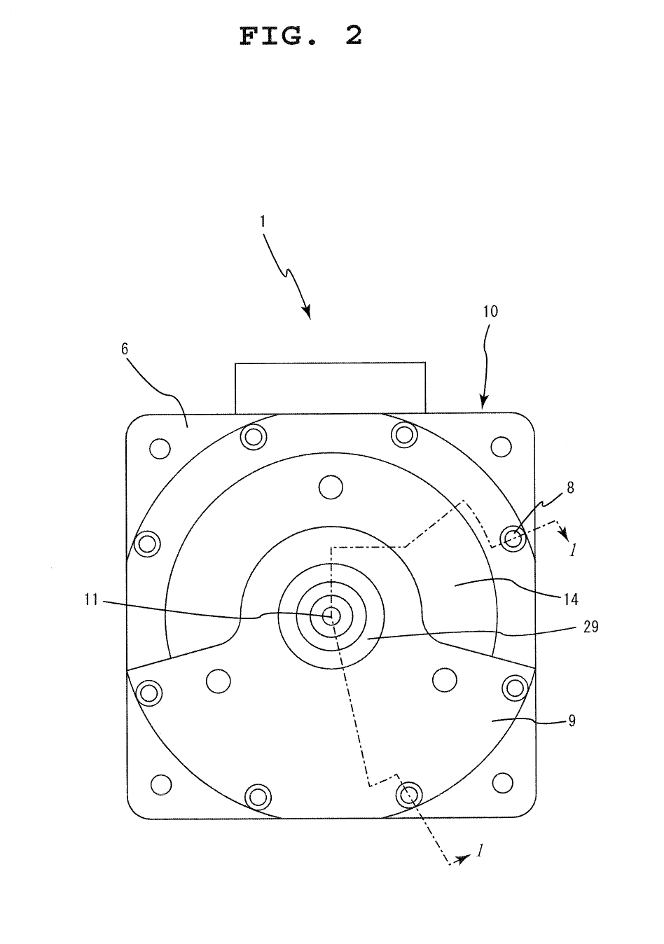

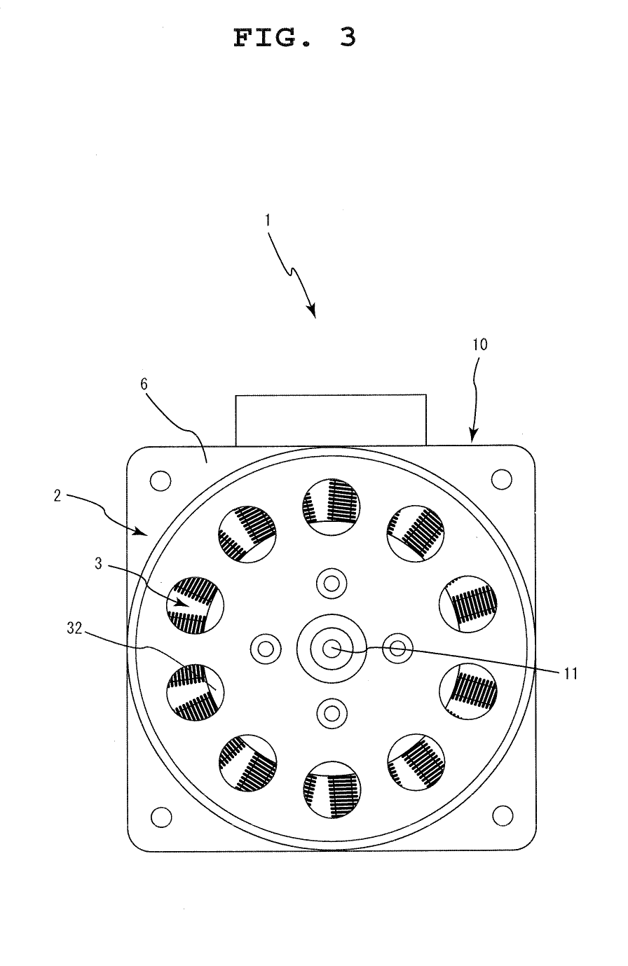

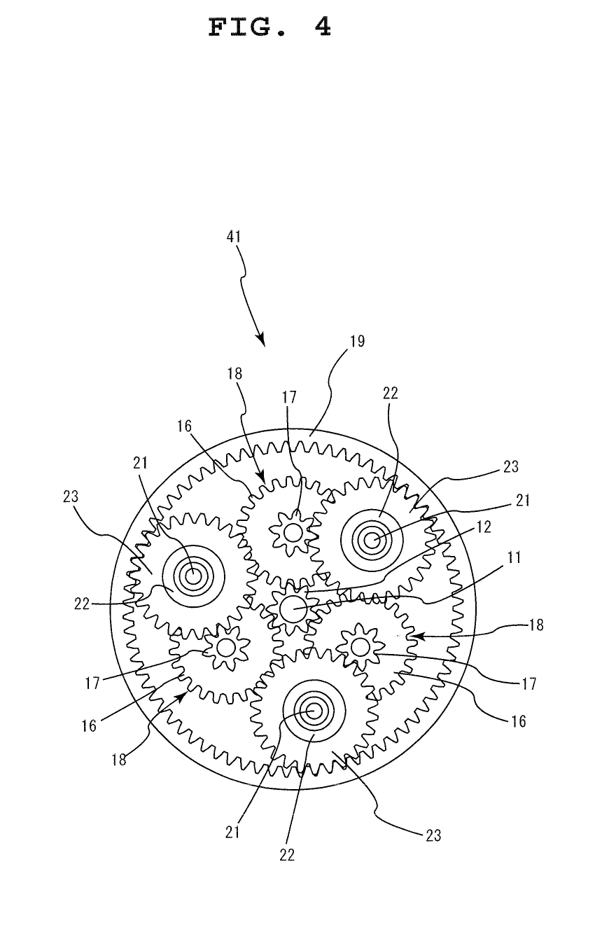

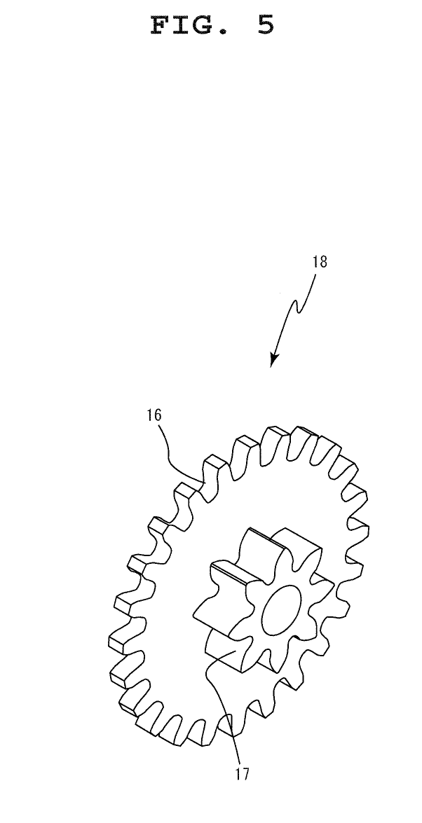

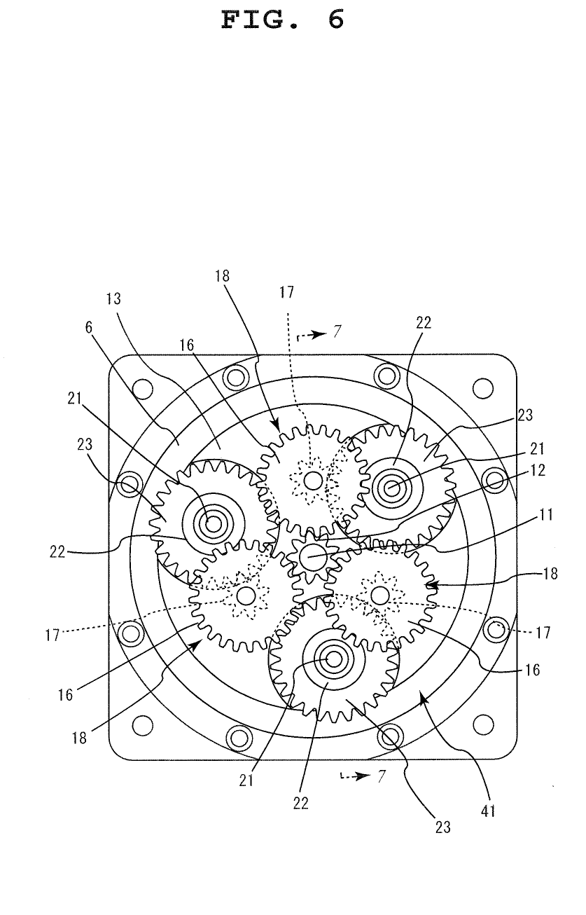

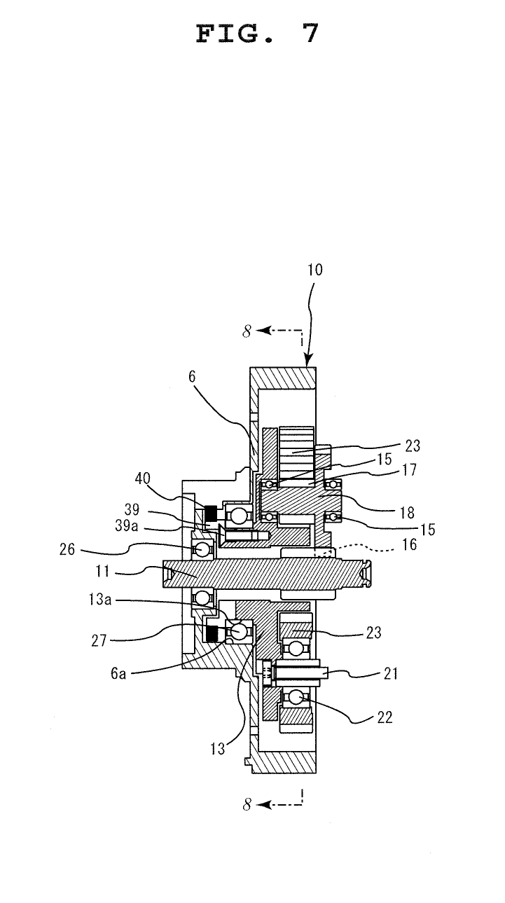

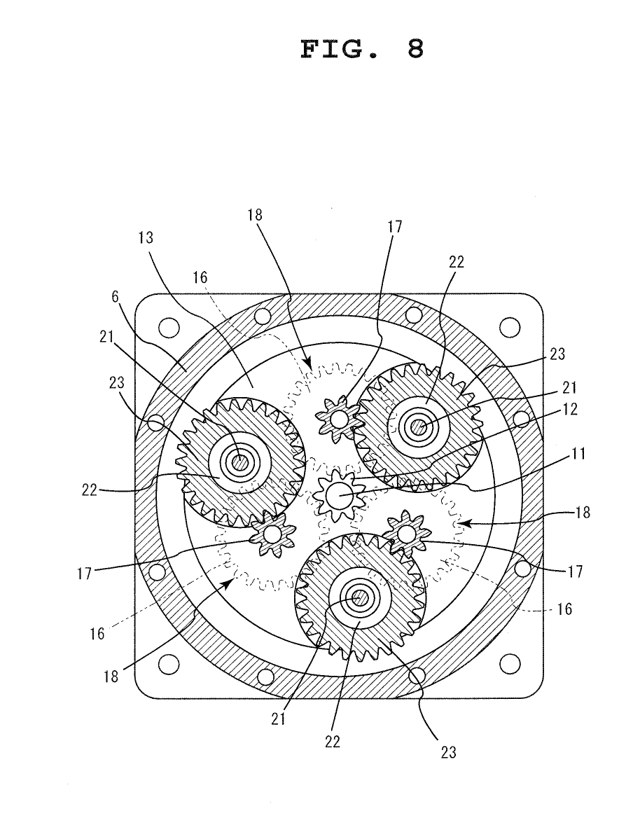

According to a first embodiment for carrying out the present invention shown in FIG. 1 to FIG. 8, reference number 1 represents a thin-type gear motor of the present invention that is thin, and is reduced in size and weight. The thin-type gear motor 1 is configured by: an outer-rotor motor 2; a planetary gear housing case 10 that is composed of a motor base 6 in which an encoder housing chamber 5 is formed that enters a free space 4 that is present in a center portion of a rotor 3 of the outer-rotor motor 2, and a bearing housing case 9 that is fixed by a plurality of screws 8 to the motor base 6 with a plate 7 therebetween and has a shallow dish-shape or of which half or more of an outer peripheral portion is cut off (half or more of the outer peripheral portion is cut off according to the embodiment of the present invention); a shaft 11 that is used for the motor 2 and is positioned within the planetary gear housing case 10; a sun gear 12 that is fixed to a section of the shaft 11 that is positioned within the planetary gear housing case 10; a reduction mechanism 41; a shaft 24 is integrally formed as required with a carrier mount 14 that serves as an output shaft of the reduction mechanism 41, has the same axial center as the axial center of the shaft 11, and is used as a cylindrical output shaft that projects further outward than the planetary gear housing case 10; a magnet attachment ring 39 that is attached by three screws 39a, 39a, and 39a to a sensor base in a section corresponding to the encoder chamber 5 of the planetary gear housing case 10; a ring-shaped magnet 40 that is attached to the magnet attachment ring 39 and serves as a rotation position information recording member that is magnetized on a side surface to provide an absolute sensor with position information; a magnetic absolute sensor 25 that is provided on a wall surface within the encoder housing chamber 5 of the planetary gear housing case 10 in a section corresponding to the ring-shaped magnet 40, and is capable of detecting the rotation angle of a sensor base 13 that rotates integrally with an output shaft after speed reduction; a ball bearing 26 that is interposed between a section near the lower end portion of the shaft 11 and the lower end portion of the motor base 6 of the planetary gear housing case 10; a ball bearing 27 that is interposed between an inner wall surface 6 near the lower portion of the motor base 6 of the planetary gear housing case 10 and an outer wall surface 13a near the lower end portion of the sensor base 13; a ball bearing 28 that is interposed between an outer peripheral portion of a base portion of the shaft 24 and the bearing housing case 9 of the planetary gear housing case 10; and a ball bearing 29 that is interposed between an inner wall surface 24a in the base portion of the shaft 24 and an upper end portion of the shaft 11. The reduction mechanism 41 is composed of: a sensor base 13 and a carrier mount 14 that are provided so as to integrally rotate within the planetary gear housing case 10 and serve as a planetary carrier; planetary two-stage gears 18, 18, and 18 that are composed of a plurality (three according to the embodiment of the present invention) of large gears 16, 16, and 16 of which both end portions are supported by the sensor base 13 and the carrier mount 14 with ball bearings 15 and 15 therebetween so as to mesh with the sun gear 12 that is fixed to the shaft 11 of the motor 2 in a section positioned within the planetary gear housing case 10, and small gears 17, 17, and 17 that are respectively provided so that the axial centers are the same as the axial centers of the large gears 16, 16, and 16; and planetary gears 23, 23, and 23 that mesh with the small gears 17, 17, and 17 of the planetary two-stage gears 18, 18, 18, also mesh with an inner gear 19 that is fixed to an inner wall surface 10a of the planetary gear housing case 10, and are rotatably attached by ball bearings 22, 22, and 22 to planetary gear shafts 21, 21, and 21 that are attached to the sensor base 13 and the carrier mount 14 using bolts 20 and 20.

The rotor 3 is configured by an outer cylinder 31 in which the shaft 11 is fixed at the center thereof and that covers a main magnet 30 disposed in the outer periphery. Reference number 32 represents a core.

In addition, when the reduction ratio is the same, compared to a typical planetary gear having a one-stage structure, the diameter can be reduced to one-third or less through use of the planetary two-stage gears 18, 18, and 18. Therefore, a reduction mechanism 41 having a small outer dimension can be achieved.

When a planetary two-stage gear 18 in which the gear ratio between the large gear 16 and the small gear 17 is not an integral multiple is used, the number of selections of gear ratio can be significantly increased. Therefore, freedom in design can be significantly improved. In particular, even in situations in which, ordinarily, the motor itself is required to be changed to obtain optimal torque, such situations can be supported without the motor being changed. Therefore, in addition to improved freedom in design, significant cost reduction can be achieved.

In this instance, assembly can be accurately and easily performed by a positioning marker for assembly being provided on the planetary two-stage gear 18.

In the thin-type gear motor 1 that is configured as described above, the rotor 3 and the shaft 11 rotate when the motor 2 is driven.

As a result of the rotation of the shaft 11, the sun gear 12 that is fixed to the shaft 11 rotates. As a result of the rotation of the sun gear 12, the large gears 16, 16, and 16 and the small gears 17, 17, and 17 of the plurality of planetary two-stage gears 18, 18, and 18 rotate at a reduced speed. In addition, the planetary gears 23, 23, and 23 that mesh with the small gears 17, 17, and 17 and the inner gear 19 rotate.

As a result of the planetary gears 23, 23, and 23 meshing with the inner gear 19 and rotating, the sensor base 13 and the carrier mount 14 serving as the planetary carrier rotate. The axis 24 that is integrally formed with the carrier mount 14 rotates.

Therefore, the rotation of the shaft 11 of the motor 2 can be reduced in speed by the meshing relationship between the sun gear 12 and the large gears 16, 16, and 16 of the planetary two-stage gears 18, 18, and 18, and the meshing relationship between the small gears 17, 17, and 17 of the planetary two-stage gears 18, 18, and 18 and the planetary gears 23, 23, and 23. As a result, the range of speed reduction can be widely set. In addition, through use of the planetary two-stage gears 18, 18, and 18, thinness, and size and weight reduction can be achieved.

In addition, as a result of the absolute sensor 25 that is disposed within the encoder housing chamber 5 that enters the free space 4 present in the center portion of the rotor 3 of the outer-rotor motor 2 in the planetary gear housing case 10, and the ring-shaped magnet 40 that is attached to the sensor base 13 in a section corresponding to the absolute sensor 25 in the encoder housing chamber 5 with the magnet attachment ring 39 therebetween, the rotation angle of the output shaft after speed reduction can be detected.

As the absolute sensor 25, in addition to the magnetic type described herein, other types of sensors, such as optical, capacitance, or contact, can also be used. In this instance, the rotation position information recording member that provides the absolute sensor 25 with position information is changed as appropriate to a slit disk or the like, depending on the type of sensor.

In addition, when load is placed on a gear, such as when high torque output is required, a lubricant such as oil is generally used. However, when a lubricant such as oil is used, oil splatter and the like occur. Therefore, the magnetic absolute sensor 25 that is capable of accurate detection even when oil splatter and the like occur is preferably used.

In the thin-type gear motor 1 configured as described above, the carrier mount 14 serves as the output shaft by the inner gear 19 being fixed. However, as a result of the carrier mount 14 and the sensor base 13 serving as the planetary carrier being fixed, the inner gear 19 can serve as the output shaft.

When the inner gear 19 serves as the output shaft in this way, the absolute sensor 15 is required to be disposed within the encoder chamber 5 so as to rotate together with the inner gear 19.

A configuration is also possible in which the planetary gears 23, 23, and 23 are omitted, and the small gears 17, 17, and 17 of the planetary two-stage gears 18, 18, and 18 and the inner gear 19 directly mesh. In this instance, the diameter of the reduction mechanism can be further reduced.

### Other Embodiments for Carrying Out the Invention

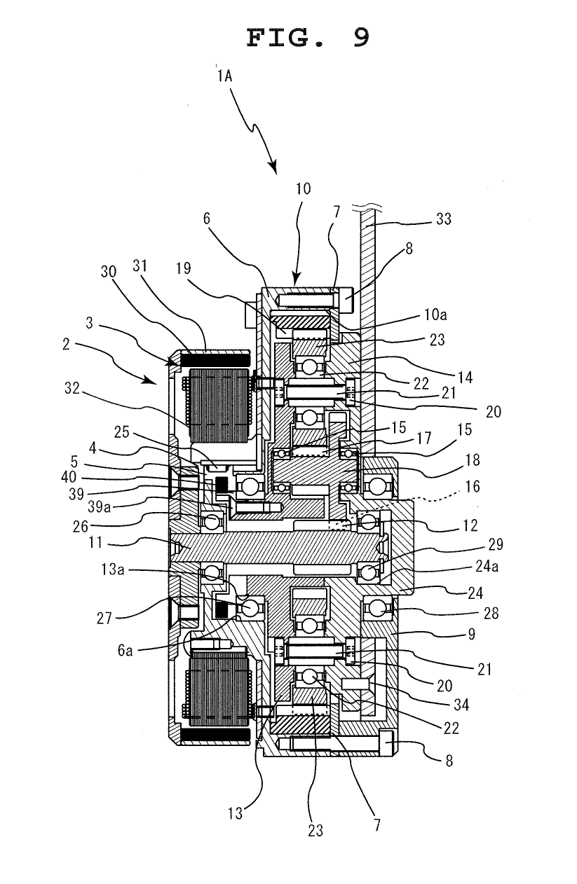

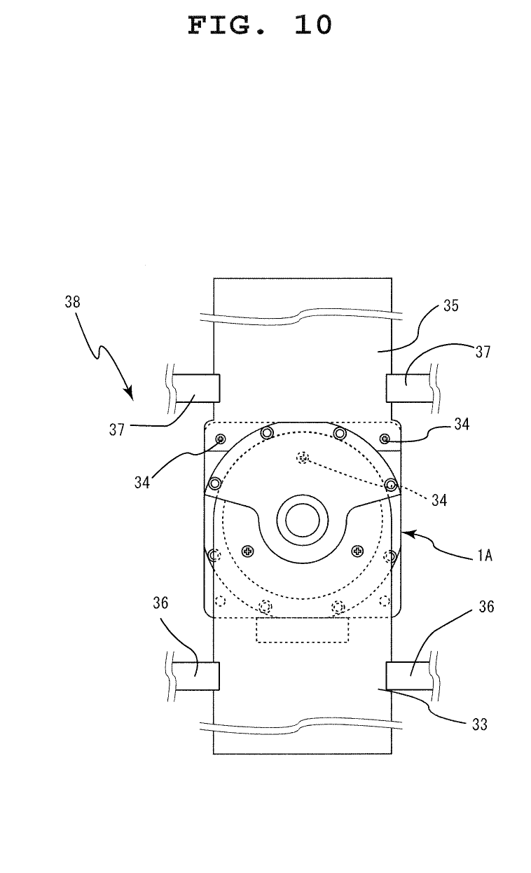

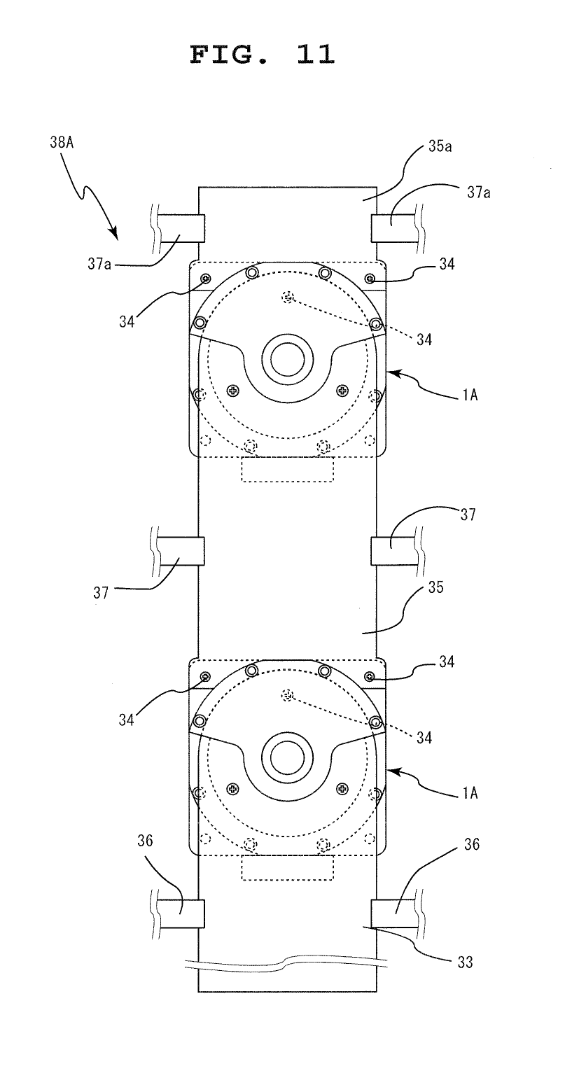

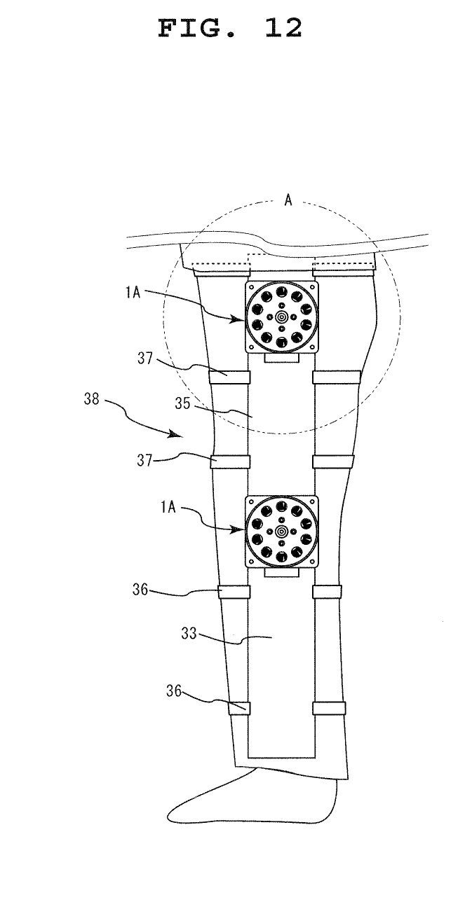

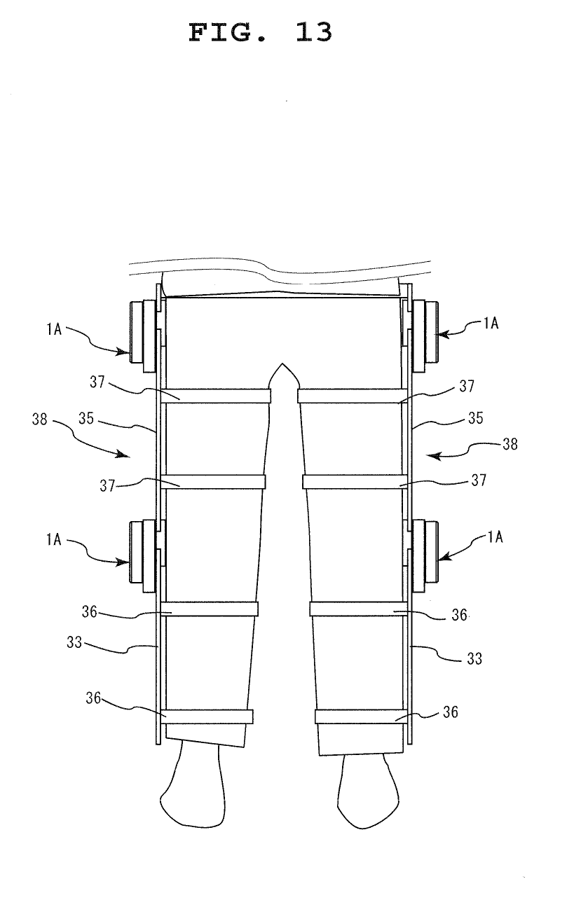

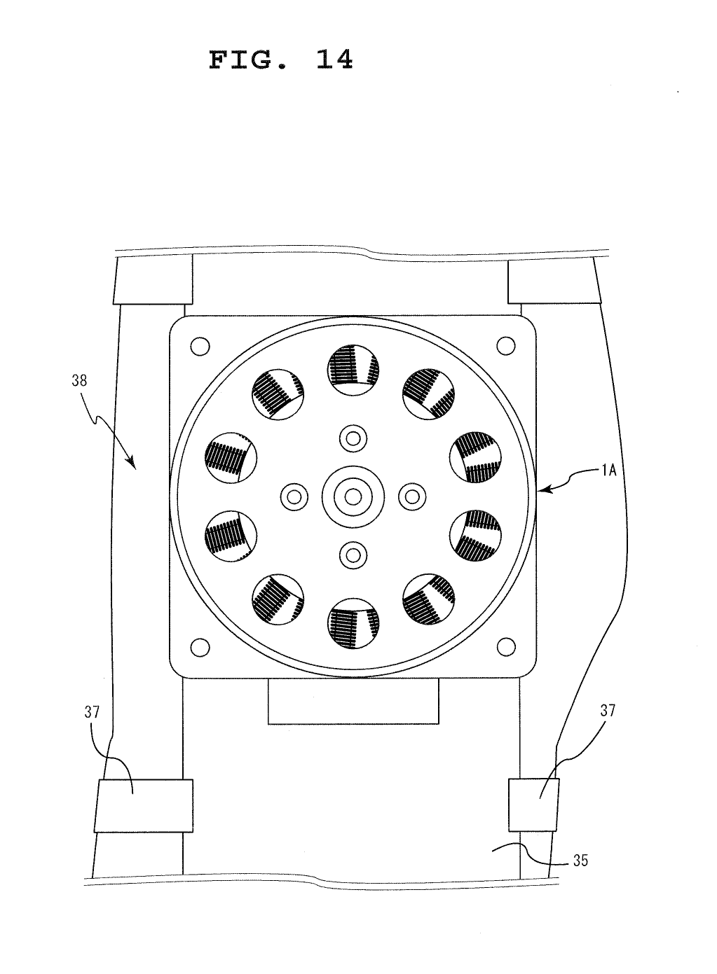

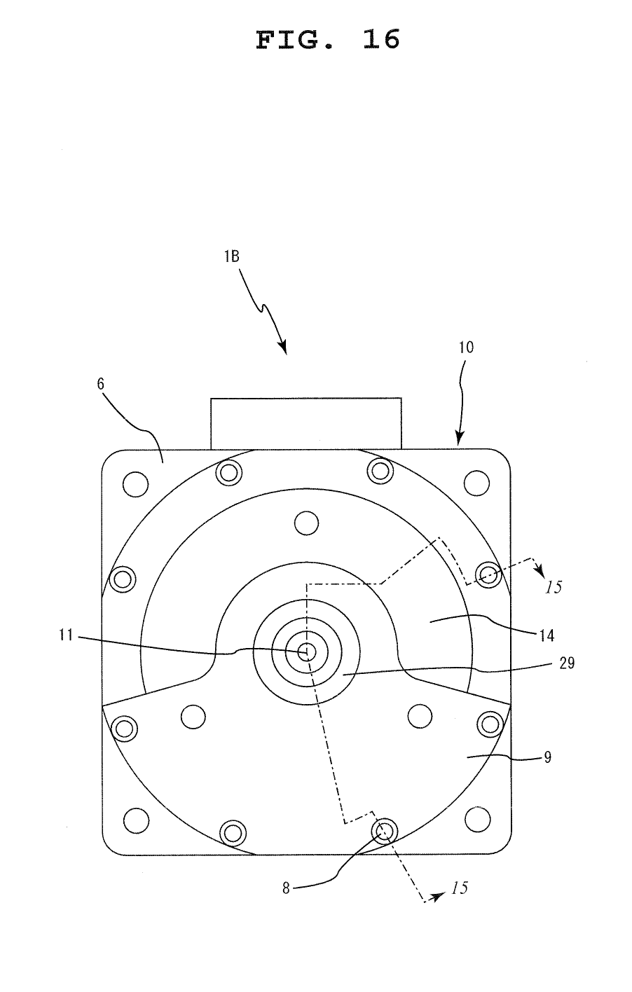

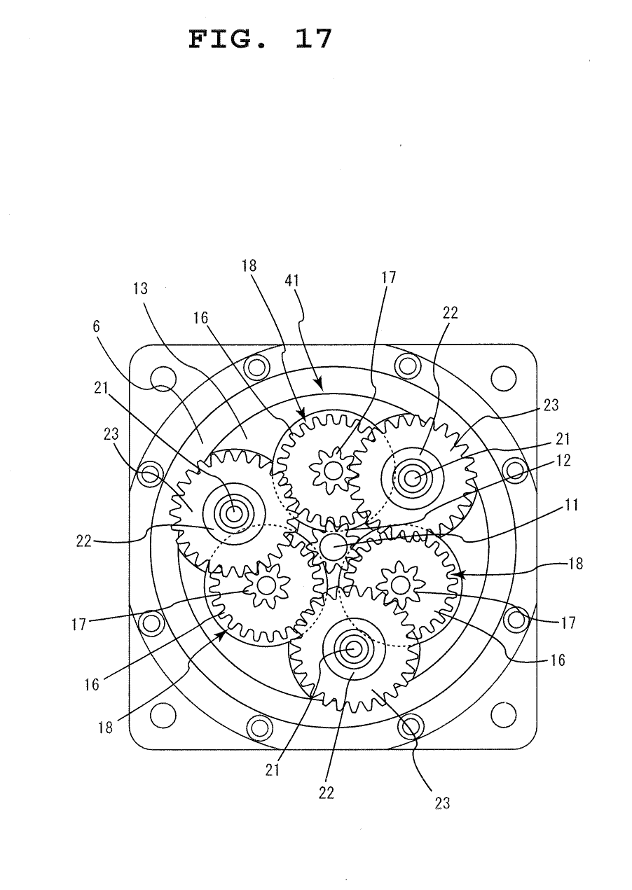

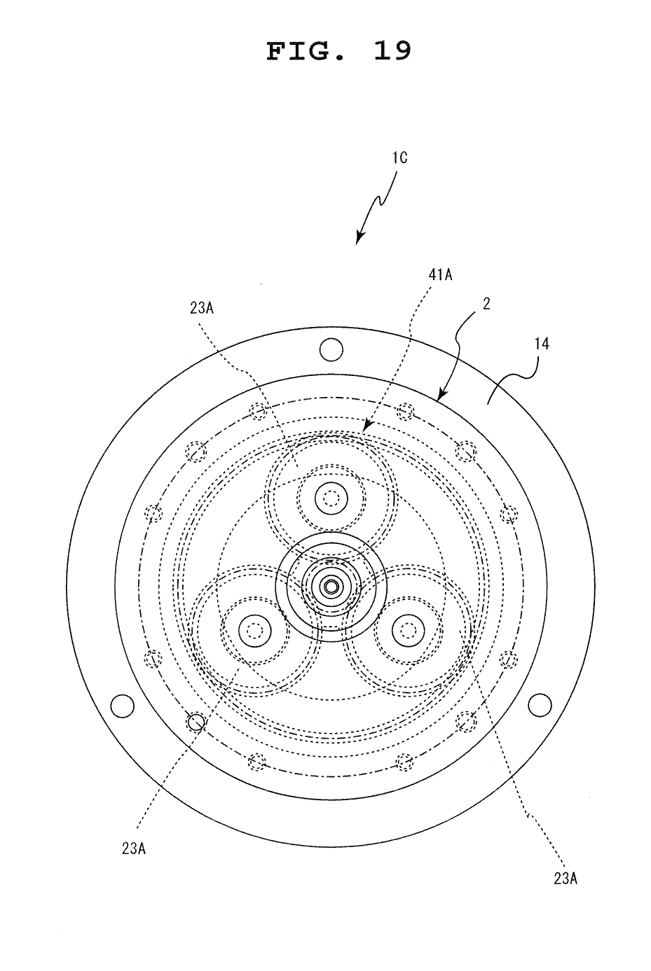

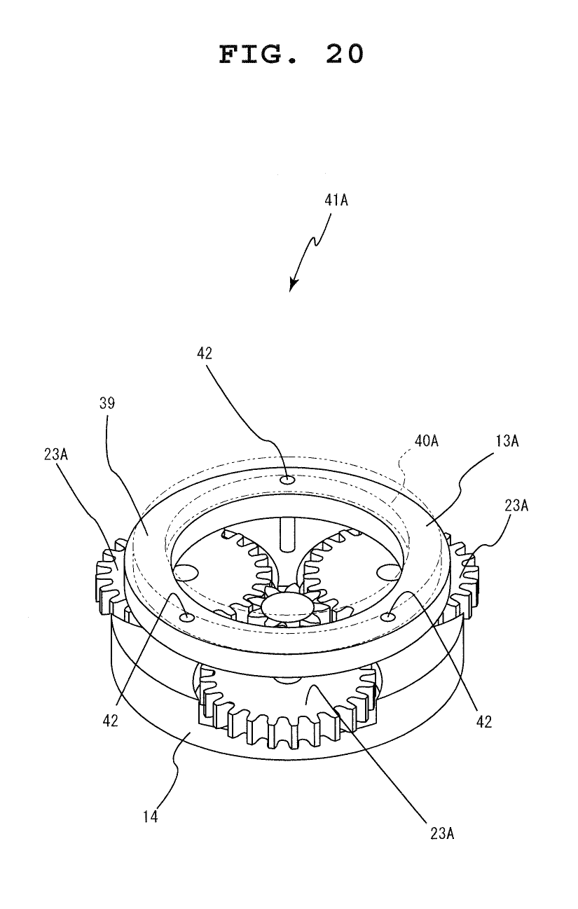

Next, other embodiments for carrying out the present invention will be described with reference to FIG. 9 to FIG. 20. In the description of the other embodiments for carrying out the present invention, constituent sections that are the same as those according to the first embodiment for carrying out the present invention are given the same reference numbers. Redundant descriptions are omitted.

A second embodiment for carrying out the present invention shown in FIG. 9 to FIG. 14 mainly differs from the above-described first embodiment for carrying out the present invention in that a muscle force assisting device 38 that uses a thin-type gear motor 1 is achieved by using: a thin-type gear motor 1A in which the shaft 24 is rotatably attached to the bearing housing case 9 by the ball bearing 28; a first arm 33 of which one end portion is fixed to the carrier mount 14 of the thin-type gear motor 1A by a plurality of screws 34, 34, and 34; a second arm 35 of which one end portion is fixed to the motor base 6 by a plurality of screws 34, 34, and 34; a first mounting member 36, such as a belt, that is attached to a section near the tip end portion of the first arm 33 and can be attached to a section that projects further than a joint section so that the section of the thin-type gear motor 1A is the joint section; and a second mounting member 37, such as a belt, that is attached to a section near the tip end portion of the second arm 35 and can be attached to a section that projects further than a joint section so that the section of the thin-type gear motor 1A is the joint section. As a result of the muscle force assisting device 38 that uses a thin-type gear motor configured as described above, the muscle force assisting device 38 can be used by being mounted on a thigh area and a lower leg area, a hip area and a thigh area, an upper arm area and a forearm area, or the like.

In addition, as a result of the carrier mount 14 of the thin-type gear motor 1A being fixed to the tip end portion of the second arm 35, and an arm 35a that uses a mounting member 37a, such as a belt, that can be attached to a hip area being attached to the motor base 6 of the thin-type gear motor 1A, a muscle force assisting device 38A that uses a thin-type gear motor 1 that can be used by being attached to the hip area and the thigh area, and even the lower leg area, can be achieved.

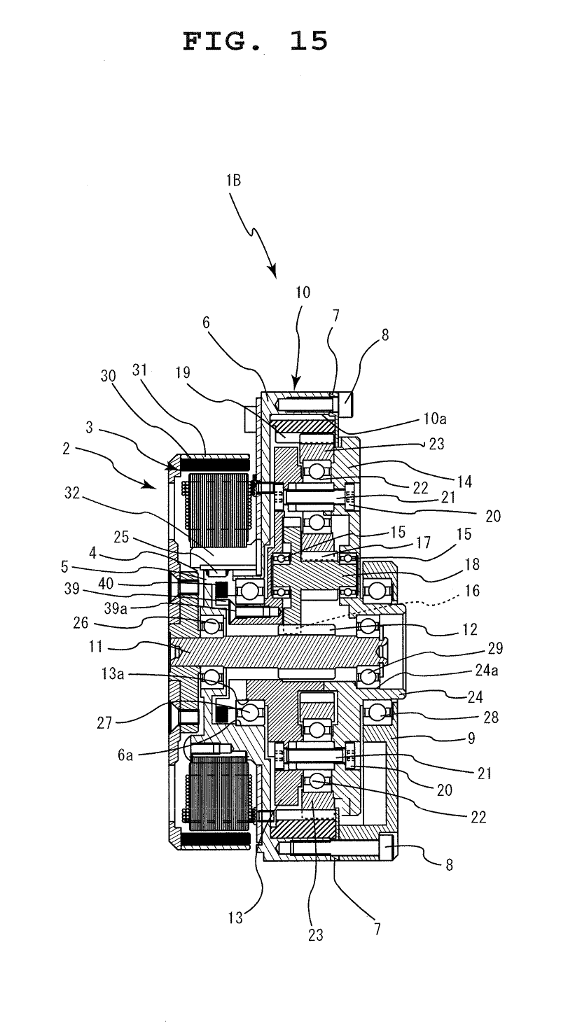

A third embodiment for carrying out the present invention shown in FIG. 15 to FIG. 17 mainly differs from the above-described first embodiment for carrying out the embodiment in that the planetary two-stage gears 18, 18, and 18 are disposed between the sensor base 13 and the carrier mount 14 so that the large gears 16, 16, and 16 are positioned on the sensor base 13 side. Even in a thin-type gear motor 1B configured in this way, working effects similar to those according to the above-described first embodiment for carrying out the present invention can be achieved. In addition, because the planetary gears 23, 23, and 23 are disposed near the carrier mount 14, the thickness of the carrier mount 14 can be reduced by an amount equivalent thereto.

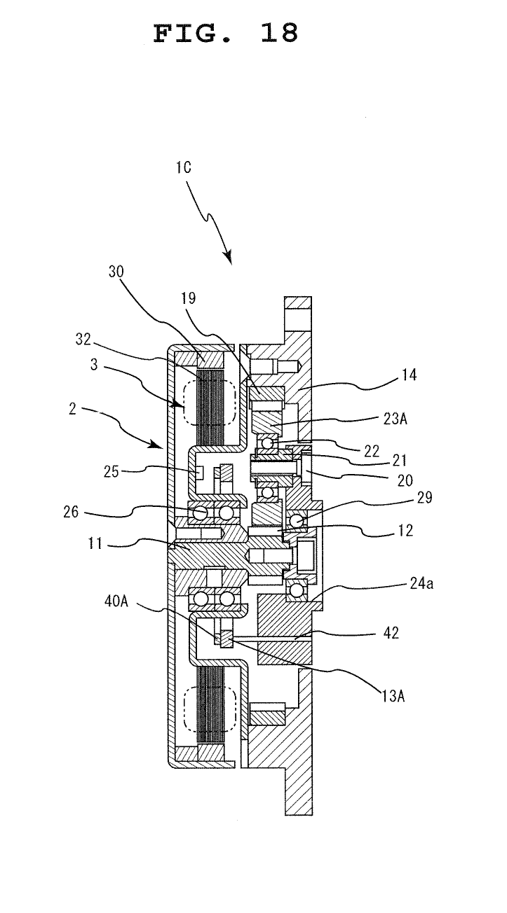

A fourth embodiment for carrying out the present invention shown in FIG. 18 to FIG. 20 mainly differs from the above-described first embodiment for carrying out the present invention in that a reduction mechanism 41A is used that is composed of the carrier mount 14 that is provided so as to rotate within the planetary gear housing case 10, and a plurality of planetary gears 23A, 23A, and 23A that are supported by the carrier mount 14 and mesh with the sun gear 12 that is fixed to the shaft 11 of the motor 2 in a section positioned within the planetary gear housing case 10 and mesh with the inner gear 19 that is fixed to an inner wall surface of the planetary gear housing case 10. In addition, the absolute sensor 25 is set on the inner bottom surface of the encoder housing chamber 5. A sensor base 13A is attached by sensor base attachment pins 42, 42, and 42 to the carrier mount 14 so as to be positioned in a section corresponding to the encoder housing chamber 5. A ring-shaped magnet 40A of which a bottom surface is magnetized is set in the sensor base 13A so as to provide the absolute sensor 25 with position information. Even in a thin-type gear motor 1C configured in this way, working effects similar to those according to the above-described first embodiment for carrying out the present invention can be achieved

Furthermore, rather than the sensor base 13A being attached using the sensor attachment pins 42, 42, and 42, the carrier mount 14 and the sensor base 13A may be attached using the planetary gear shafts 21, 21, and 21 in a manner similar to that according to the above-described first embodiment for carrying out the present invention.

In addition, the inner gear 19 may be an output shaft in a manner similar to that according the above-described first embodiment for carrying out the present invention.

As described above, as a result of the planetary gear shafts 21, 21, and 21 being commonly used as rotation transmitting members, the number of components can be reduced. Furthermore, the planetary gears 23, 23, and 23 may be formed having a structure that is supported on both sides by the carrier mount 14 and the sensor base 13A. Therefore, even when unbalanced load occurs, shaft instability and the like can be prevented.

The present invention is used in an industry for manufacturing thin-type gear motors having high torque output and muscle force assisting devices using a thin-type gear motor.

What is claimed is:

1. A thin-type gear motor comprising:
an outer-rotor motor;
a planetary gear housing case in which an encoder housing chamber is formed that enters a free space present in a center portion of a rotor of the outer-rotor motor;
a reduction mechanism that is rotatably provided within the planetary gear housing case, and that reduces the speed of rotation of a shaft of the motor positioned within the planetary gear housing case using planetary gears and transmits the speed-reduced rotation to an output shaft;
a rotation position information recording member that is provided in a section of the reduction mechanism corresponding to the encoder housing chamber of the planetary gear housing case and provides an absolute sensor with position information; and
the absolute sensor that is provided within the encoder housing chamber of the planetary gear housing case and detects a rotation angle of an output shaft of the reduction mechanism after speed reduction based on the information from the rotation position information recording member.

2. The thin-type gear motor according to claim 1, wherein:
the reduction mechanism is composed of
a sensor base and a carrier mount that are integrally provided within the planetary gear housing case and serve as a planetary carrier,
planetary two-stage gears that are composed of a plurality of large gears that are supported by the sensor base and the carrier mount so as to mesh with a sun gear that is fixed to the shaft of the motor in a section positioned within the planetary gear housing case, and small gears that are respectively provided so that axial centers are the same as the axial centers of the plurality of large gears; and
a plurality of planetary gears that are supported by the sensor base and the carrier mount, and that mesh with the planetary two-stage gears and mesh with an inner gear that is fixed to an inner wall surface of the planetary gear housing case.

3. The thin-type gear motor according to claim 2, wherein:
a gear ratio of the large gear and the small gear of the planetary two-stage gear is not an integral multiple.

4. A muscle force assisting device that uses a thin-type gear motor comprising:
a thin-type gear motor that is composed of
an outer-rotor motor,
a planetary gear housing case in which an encoder housing chamber is formed that enters a free space present in a center portion of a rotor of the outer-rotor motor,
a reduction mechanism that is rotatably provided within the planetary gear housing case, and that reduces the speed of rotation of a shaft of the motor positioned within the planetary gear housing case using planetary gears and transmits the speed-reduced rotation to an output shaft,
a rotation position information recording member that is provided in a section of the reduction mechanism corresponding to the encoder housing chamber of the planetary gear housing case and provides an absolute sensor with position information, and
the absolute sensor that is provided within the encoder housing chamber of the planetary gear housing case and detects a rotation angle of an output shaft of the reduction mechanism after speed reduction based on the information from the rotation position information recording member;
a second arm of which one end portion is attached to the planetary gear housing case of the thin-type gear motor;
a first arm of which one end portion is attached to an output shaft of the thin-type gear motor;
a first mounting member that is attached to a section near the tip end portion of the first arm and attached to a section projecting further than a joint section so that the thin-type gear motor section is the joint section; and
a second mounting member that is attached to a section near the tip end portion of the second arm and attached to a section projecting further than a joint section so that the thin-type gear motor section is the joint section.

5. The muscle force assisting device that uses a thin-type gear motor according to claim 4, wherein:
the reduction mechanism is composed of
a carrier mount that is provided so as to rotate within the planetary gear housing case and in which a sensor base is set in a section corresponding to the encoder housing chamber, and
a plurality of planetary gears that are supported by the carrier mount, and that mesh with a sun gear that is fixed to the shaft of the motor in a section positioned within the planetary gear housing case and mesh with an inner gear that is fixed to an inner wall surface of the planetary gear housing case.
